(19) United States
(12) Patent Application Publication
(10) Pub. No.: US 2006/0206320 A1
(43) Pub. Date: Sep. 14, 2006

(54) Apparatus and method for noise reduction and speech enhancement with microphones and loudspeakers

(76) Inventor: Qi P. Li, New Providence, NJ (US)

Correspondence Address: Kao H. Lu, 686 Lawson Ave., Havertown, PA, 19083, US

(21) Appl. No.: 11/374,511

(22) Filed: Mar. 13, 2006

Related U.S. Application Data
(60) Provisional application No. 60/661,586, filed on Mar. 14, 2005.

(51) Int. Cl. G10L 21/02

(52) U.S. Cl. 704/226

(57) ABSTRACT

The present invention helps to reduce the noise level and to enhance the quality of speech signals, in communications, computers, entertainment and other applications, where microphones and loudspeakers are involved. Additionally, the invention includes a new noise reduction and speech enhancement algorithm which is created based on the principles of human hearing mechanism. Further, the algorithm uses a new set of speech recognition parameters instead of just signal-to-noise ratio (“SNR”) as used in the prior art.

### CROSS REFERENCE APPLICATIONS

This application claims priority from U.S. Provisional Patent Application No. 60/661,586, filed on Mar. 14, 2005.

### FIELD OF THE INVENTION

The present invention can be implemented in a single chip as an electrical component for audio signal processing. The chip is programmable and configurable, and more than one of the same chips can be linked and combined to perform more complicated tasks, such as microphone array signal processing. Each chip can be used as an independent module and can be configured as a component with one or more than one audio signal processing functions. The size of each chip can be as small as the size of a resistant or capacitor. The chip has low power consumption and can be mass produced in low cost. Therefore, the new invention can be implemented in many different applications as an electronic component in a system design.

Because the invention, the chip and algorithm, has been designed in configurable and programmable modules through the hardware or the software; therefore, the invention can save time in software development and hardware design and reduce the cost in developing a system having audio signal processing features.

### BACKGROUND OF THE INVENTION

The speech signal captured by a traditional microphone is susceptible to noise degradation which reduces the speech perceptual quality and intelligibility. Furthermore, noise in speech could deteriorate the performance of an automatic speech recognition (“ASR”) system and render it less accurate. In general, a voice system/device use a noise reduction or noise canceling module to reduce the amount of noise in speech signal while preserving the overall speech quality. Traditionally, the voice system/device uses a general purpose DSP or CPU to carry out such techniques with other applications. The current invention, the entire noise reduction function, is implemented on a silicon die or chip, which can be a component of an electronic device such as a microphone or a loudspeaker. Using this invention, a noise reduction module can be easily integrated into an application system to deuce noise without any concerns of software interfaces or of using the computational power in the general purpose CPU.

Most of the traditional noise reduction algorithms are based on Wiener filter, which consists of three key components: frequency analysis, Wiener filtering, and frequency synthesis. The frequency-analysis component is for the purpose of transforming the wideband noisy speech sequence into the frequency domain so that the subsequent analysis can be performed on a sub-band basis. This is achieved by the short-time discrete Fourier transform (DFT). The output from each frequency bin of the DFT represents one new complex valued time-series sample for the sub-band frequency range corresponding to that bin. The bandwidth of each sub-band is given by the ratio of the sampling frequency to the transform length. A system using the Wiener filter will estimate the clean-speech spectrum from the noisy-speech spectrum. The system explores the short-term and long-term statistics of noise and speech, as well as the segmental SNR, to support the Wiener gain filtering, and then pass the noisy-speech spectrum through the Wiener filter, which generates an estimate of the clean-speech spectrum. In the last step, use the frequency synthesis, an inverse process of the frequency analysis, to reconstruct the clean-speech signal and to produce the estimated clean-speech spectrum.

The problem with these traditional approaches is that the decomposition is not tuned to human ear model. Instead, the traditional approaches all base on the Fourier Transform. Another problem is that the parameters of the processing steps are primarily based on SNR. Both problems limit the performance of the noise reduction and the speech enhancement. Therefore, there is a need for a better approach of reducing noise and enhancing speech signals.

### SUMMARY OF THE INVENTION

The present invention reduces the noise level and enhances the speech quality in communication, entertainment and other applications, where microphones and loudspeakers are involved. Additionally, the invention includes a new noise reduction and speech enhancement algorithm which is created based on principles of human hearing mechanism. Further, the parameters of the algorithm are tuned according to a new set of speech recognition related criteria instead of just signal-to-noise (“SNR”) ratio as used in the prior art.

The present invention is a better method than the teaches of the prior art in noise reduction (U.S. Pat. No. 6,745,155, U.S. Pat. No. 6,732,073, U.S. Pat. No. 5,974,373) for the following reasons:
By utilizing the state-of-the-art system-on-chip technique, the entire noise reduction system can be fabricated into one silicon die which is so small that it can be easily incorporated into the microphone housing or fabricated onto a Micro-Electro-Mechanical System (“MEMS”) microphone component.
For the same reason, the noise reduction feature is also easy to be implemented into a loudspeaker.
The preferred noise reduction and speech enhancement algorithm is the Cochlear Transform which simulates more close to the human hearing system with a feedback loop to tune its performance in terms of speech recognition criteria. The algorithm produces superior results to those algorithms tuned in terms of SNR.
The invention reduces the software work needed in a system design and makes the whole application system design easier and more reliable.

### BRIEF DESCRIPTION OF THE DRAWING

Other objects, features, and advantages of the present invention will become apparent from the following detailed description of the preferred but non-limiting embodiment. The description is made with reference to the accompanying drawings in which:

FIG. 1. is an illustration of a microphone with a noise reduction computation unit built into the microphone housing;

FIG. 2. is an illustration of a loudspeaker with a noise reduction computation unit built into the loudspeaker;

FIG. 3. is a diagram of basic components in a noise reduction computation unit where a noise reduction method is implemented;

FIG. 4. is a diagram of the basic components of noise reduction computation unit working with a speech signal receiving component such as a transducer or microphone component;

FIG. 5. is a diagram of the components of noise reduction computation unit working with a speech generating component such as a loudspeaker;

FIG. 6. is a diagram complete noise reduction, speech receiving and speech generating system such as a hearing aid;

FIG. 7. is a diagram of the cochlear transform (CT);

FIG. 8. is a diagram of the method to reduce noise in speech signal from a single microphone with feedback parameter adaptation/adjustment;

FIG. 9. is a diagram of the method to reduce noise in speech signal from an array of microphones with feedback parameter adaptation/adjustment;

FIG. 10. is a comparison between FFT and CT spectrums. The solid lines are computed from clean speech recorded by a close-talking microphone and the dished lines are computed from noisy speech data recorded by a remote microphone while the speaker is in a moving car;

FIG. 11. is an example of using the invented noise reduction chip for cell phone applications. There are two channels in the chip. One channel removes the background noise received from the microphone; another channel removes the noise from the entire communication channel before sending the signal to the loudspeaker.

### DETAILED DESCRIPTION OF THE INVENTION

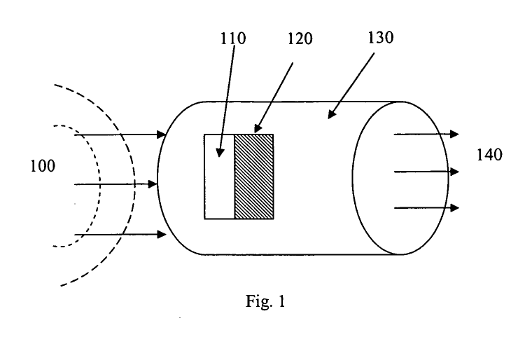

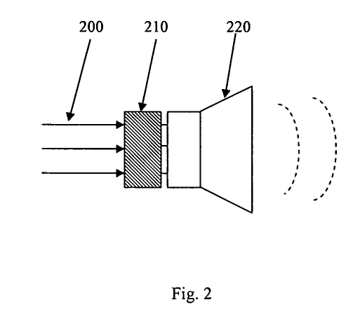

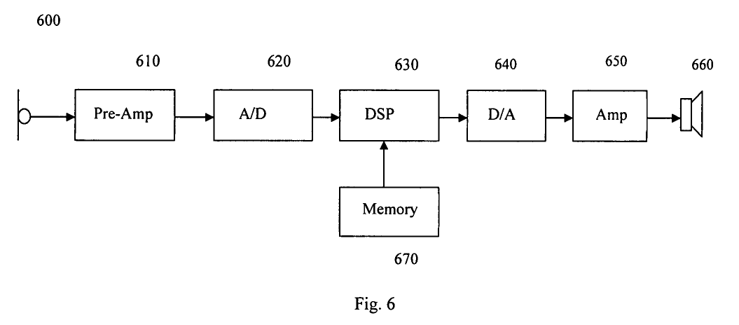

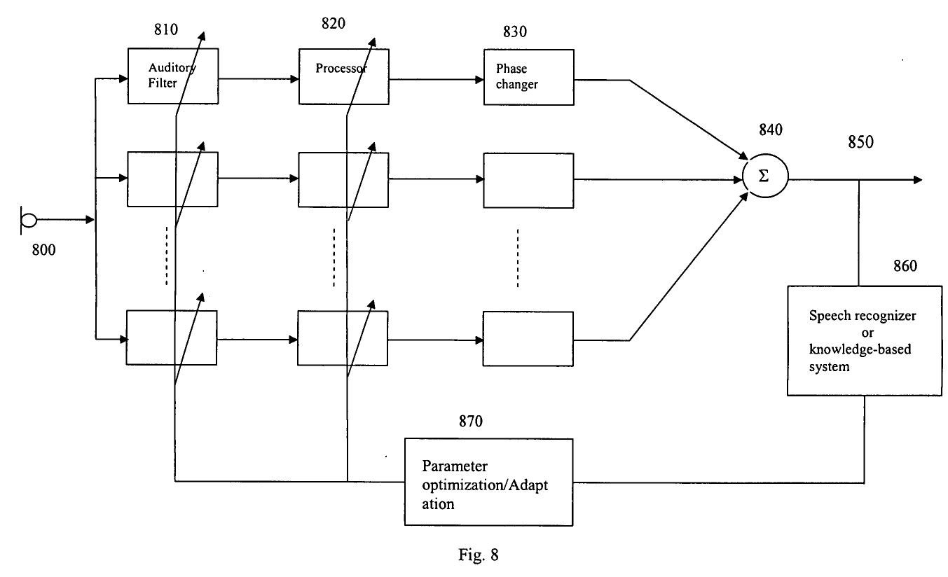

Referring to FIG. 1, the components in the invention are:
A microphone 130 that comprises of a transducer 110 and a silicon computation unit 120. The microphone is capable of converting speech signal input with noise 100 into noise reduced and enhanced speech signal 140.
A loudspeaker 230 that comprises of a computation unit 220 that converts noisy digital speech signal 200 into enhanced or cleaned speech. Referring to FIG. 2.
A complete computation unit FIG. 6 consists of a microphone 600, a pre-amplifier 610, an analog-to-digital converter (“A/D”) 620, a digital signal processor (“DSP”) 630, a digital-to-analog converter (“D/A”) 640, an amplifier 650, a loudspeaker 660 and a memory 670.
   A method of reducing noise level in speech signal consists of one 800 or an array of microphones 900, a bank of auditory filters 810, a processor 820, a signal phase changer 830, an adder 840, a speech recognizer or knowledge-based system 850, and an parameter optimizer or adaptor 870. See FIGS. 8 & 9.

The noise reduction and speech enhancement devices of the present invention comprise of two major parts: a computation unit either with a sound receiving unit as shown in FIG. 1 or with a sound generating unit as shown in FIG. 2. The computation unit can be a programmable circuitry with an implementation of the noise reduction and the speech enhancement algorithm. The sound receiving unit can be a microphone component, and the sound generating unit can be a loudspeaker. One embodiment of invention is shown in FIG. 1 where the computation unit is within the sound receiving unit—a microphone. Another embodiment of the invention is shown in FIG. 2 where the computation unit is within the sound generating unit—a loudspeaker. Alternatively, the computation unit can work as a separate module at any stage within an application system, such as a wireless handset, conference phone, speaker phone, hearing aid, earphone, etc.

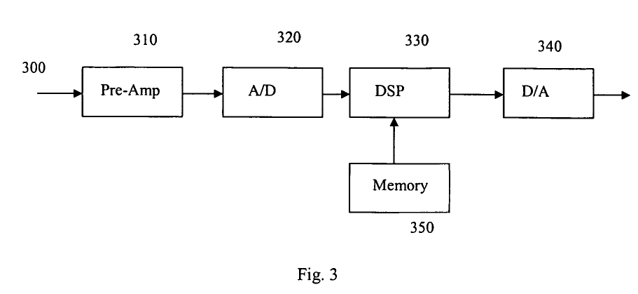

The computation unit as shown in FIG. 3 is a system-on-chip realization of the invented noise reduction and speech enhancement method. The implementation consists of the following components: referring to FIG. 3, a pre-amplifier 310, an analog-to-digit (“A/D”) converter 320, a digital signal processor (“DSP”) 330, a memory 350 including RAM or ROM, and a digit-to-analog (“D/A”) converter 340. The noise reduction and speech enhancement algorithm and its corresponding software are pre-stored in the memory. All the functions can be fabricated in one silicon die, and the die can be packaged as a chip when necessary. Alternatively, the die can also be packaged on a circuit board directly as system-on-board packaging. Also, one die may support multiple channel noise reduction and speech enhancement.

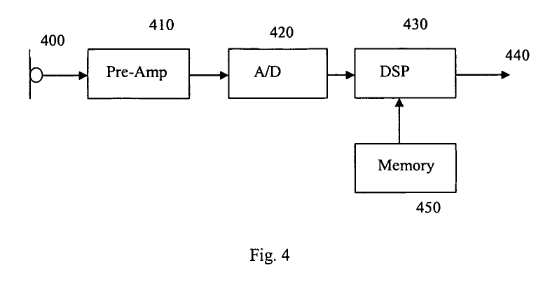

FIG. 4 is the structural diagram of the embodiment shown in FIG. 1 with a microphone component and the computation unit manufactured in one microphone housing. The sound received from a microphone 400 is pre-amplified 410 and converted into digital signal 420. The digital signal processor (“DSP”) 430 runs the software pre-stored in the memory 440, which will reduce noise in the digital signal. Alternatively, as the MEMS, the microphone can be manufactured on silicon, the MEMS microphone and the computation unit can be on one single die together to reduce the space and cost. The output of the embodiment is digitized or analogue sound signals.

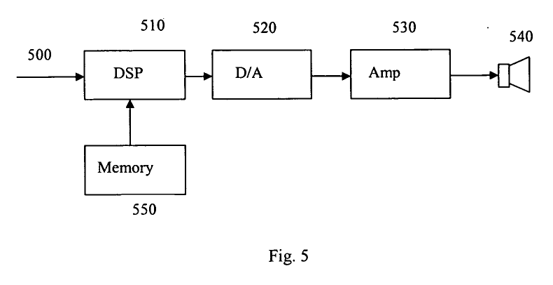

FIG. 5 is the structural diagram of the embodiment shown in FIG. 2 with a loudspeaker component and the computation unit built in one loudspeaker housing or connected to each other. The DSP 510 working with the software program pre-stored in the memory 500, it reduces the noise component from the inputted digitized sound signal 500. The cleaned digital signal is then converted into analog signal through a digital-to-analog (“D/A”) converter 520. The analog signal is then amplified through an analog amplifier 530 before being fed into a loudspeaker 540. Alternatively, as a MEMS speaker can be manufactured on silicon, the MEMS speaker and the computation unit can be on one single die together to reduce the space and cost. The output of the embodiment is processed sound with reduced noise level.

For a hearing aid and other special applications, the entire system can be implemented in one single silicon die as shown in FIG. 6 in a system-on-chip implementation. Also, one chip may be fabricated to support two or more than two channel noise reduction and speech enhancement; thus, the system in FIG. 4 and FIG. 5 may share one chip.

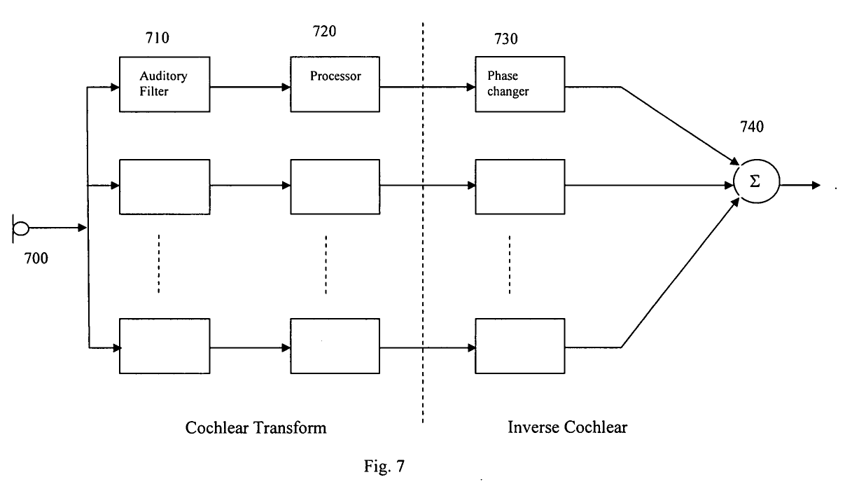

The invention uses a Cochlear Transform (CT) algorithm to replace the Fourier Transform in traditional noise reduction as shown in FIG. 7, because CT can facilitate the hardware implementation and provide a better performance. The parameters of the transform can be adjusted or adapted by a feedback method as shown in FIG. 8. After simulating the mechanism of the human hearing system by mathematical equations, the inventor invented the time-to-frequency transform called cochlear transform (CT) as shown in FIG. 7. In the CT, the input signal is decomposed into different frequency bands by a bank of auditory filters 710. The time and frequency domain responses of the auditory filters 710 are very close to the basilar membrane inside of human cochlea. Through the coupling with the processor 720, the sound signal is converted into the frequency domain; thus, thresholds or nonlinear operations, similar to the non-linearity in the human hearing system, can be applied to remove the noise in each of the frequency bands using the processor units. Furthermore, the output of each band will be re-synthesized through phase changes 730. We call the synthesizing process the Inverse Cochlear Transform (ICT). Since this approach is very similar to the function of a human hearing system, we can obtain better performance than that of other approaches.

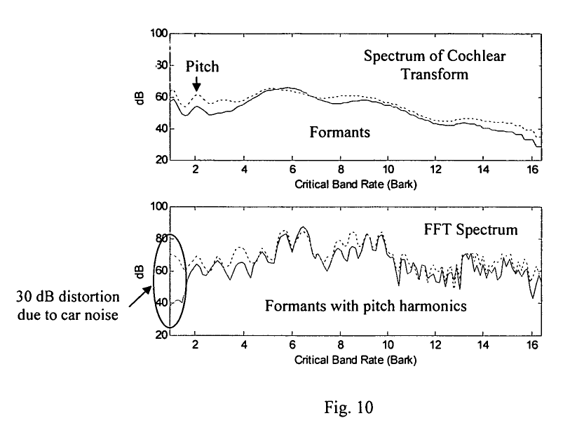

An example of comparing the CT spectrum with the FFT spectrums from the same window is shown in FIG. 10. Compared to the FFT, the new CT has the following advantages: (1) it can accurately extract pitch and formant information without any pitch harmonics in its spectrum, which will be helpful in reducing low frequency noise, such as car noise; (2) the CT is robust to background noises; and (3) the CT does not introduct computational noises, such as the pitch harmonics in the frequency domain. We use Table 1 to list the significance of the technique and compare it with FFT.

TABLE 1
Comparison of Fast Fourier Transform and Cochlear Transform

| Techniques | Advantage | Disadvantage |
|---|---|---|
| Existing Fast | Fast in computation | Pitch harmonics |
| Fourier | | Computational noise |
| Transform | | No clear pitch information |
| (FFT) | | in FFT-based features |
| Invented | No pitch harmonics | |
| Cochlear | No computational noise | |
| Transform | Pitch information is in the CT | |
| | spectrum. | |
| | Fast algorithm has been | |
| | developed. | |

The cochlear transform can also be used for feature extraction in the automatic speech recognition, audio coding, machine translation, and other signal processing applications.

The present invention further includes a new method to adapt or adjust the system parameters using the ASR error rates or other information as shown in FIG. 8. The input speech signal 800 is decomposed on a bank of auditory-based filters 810 to form different frequency bands by the cochlear transform. Each filter has a specific characteristic frequency, which produces the maximum response to the speech signal in that band. The frequency response of the auditory-based filter bank is designed according to the cochlear located in the human inner ear. The outputs from the auditory-based filter are then processed by a special nonlinear processor 820 which can be realized in forms of a hard-limit threshold, a log or nonlinear function, a mathematic equation, or an artificial neural network. The outputs of the nonlinear processors after a signal phase changer 830 are added through an adder 840 to re-synthesis the processed and cleaned speech signal 850. The processed speech signal is then evaluated by an ASR system or a knowledge-based system 860. The evaluation results in terms of the quality of the processed speech or recognition error rate are then fed back through a parameter optimizer or adaptor 870 to adjust the parameters in the auditory filters and the nonlinear processor to further improve the quality of the processed sound. The noise reduction method is implemented on the computation unit.

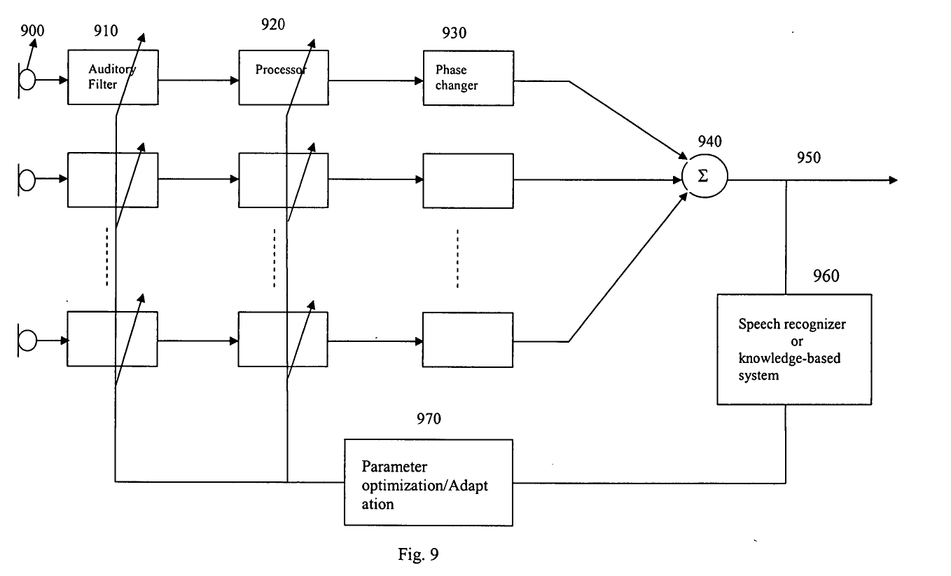

Another realization of the new method to reduce noise level in speech signal by simulating the function of the human hearing system is shown in FIG. 9. The input speech signal is directly captured to an array to microphones 900. An array of auditory filters 910, either digital, analog, or mechanical such as basilar membrane, with different frequency responses are used to decompose speech signal into different frequency bands according to the cochlear located in the human inner ear. The outputs from the auditory-based filter are then processed by a special nonlinear processor 920 which can be realized in forms of a hard-limit threshold, a log or nonlinear function, or a mathematic equation. The outputs of the nonlinear processors after a signal phase changer 930 are added through an adder 940 to re-synthesis the cleaned speech signal 950. The processed speech signal is then evaluated by an ASR system or a knowledge-based system 960. The evaluation results in terms of the quality of the processed speech are then fed back through a parameter optimizer or adaptor 970 to adjust the parameters in the auditory filters and the nonlinear processor to further improve the quality of the processed sound. The entire system shown in FIG. 9 can be implemented in one silicon die or chip.

The audio signal processing functions which can be loaded into the chip include but not limited to:
Array signal processing
One-channel, two-channel, or multi-channel echo cancellation
Noise reduction and speech enhancement
Equalization
Audio coding and decoding
Voice variation (change the speaker's voice by enhancing certain frequencies so the voice sounds better or with special effect, or even change the sound like another person)
Speech feature extraction
Keyword spotting
Speech recognition

Each chip may have one or more than one of the audio processing functions. Each of the functions can be implemented as a software module in a ROM or other memory components in the chip. Upon the needs of applications, one or more than one of the software functions can be selected and put together in the ROM of the chip, and more than one chip can be used to construct a complicated system if needed.

The chip is a system-on-chip structure comprising (more or less):
Traditional or MEMS microphone, one or more than one microphone component can be on the same silicon chip by using the MEMS technique;
Preamplifier
ADC
DAC
AGC, automatic gain control
DSP
ROM
RAM
Amplifier
Sound or voice detector
Control lines (for turning off the processing function or other control functions)
I/O interface, such as USP
Lines or bus for communications and controls with other chips
   The chip may need the following supports from outside:
Power supply
Oscillator or resonator signals
Additional ROM or other memory
   The chip can receive audio signals from:
One or multiple outside microphone components
Internal MEMS microphones
Line-in
Digital I/O buses
   The chip can output audio or control signals from:
DAC output
Internal analogue amplifier
Digital I/O buses
   The chip can be used in the following ways:
Place after a microphone or inside a microphone house;
Place before a loudspeaker or inside the loudspeaker;
Insert in an analogue circuit;
Insert in a digital circuit; or
Use as a Codec chip
   More than one of the chips can be used in parallel, in sequential, or in a combination:
In parallel: For example, two chips, with two microphone inputs in each of the chips, can be used in parallel to support a four-channel microphone array, and both chips can be synchronized by digital communications between them.
In sequential: For example, one chip for noise reduction and feature extraction can be followed by a chip for speech recognition.

An audio signal processing system can be configured by selecting necessary software functions and necessary number of the chips, and then loading the software functions into the ROM and connecting the chips together. This kind of configuration needs much less work on software development and hardware design than a traditional approach.

The software function can be put in the chip's ROM during the chip manufacture.

Several software functions can be combined to one software module. Similarly, more than one of the die of the chip can be connected and packaged as a new chip.

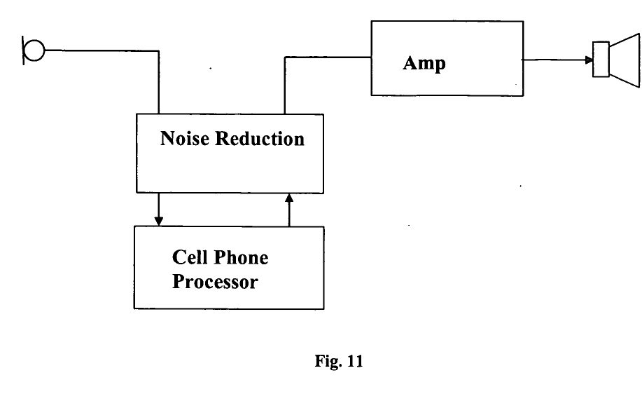

Examples of Embodiments and Applications:
A chip with one analogue input and one analogue out and with noise reduction software module in its ROM can be used in a cell phone for noise reduction. The chip can be placed before the power amplifier for a loudspeaker. FIG. 2.
A chip with one analogue input and one analogue out and with noise reduction software module in its ROM can be place inside the house of a microphone component as shown in FIG. 1 to work as a noise-reduction microphone.
A hearing aid can be constructed by a microphone component, the chip loaded with frequency equalizer and noise reduction software, and a small loudspeaker. The parameters of the equalizer can be determined and modified from a patient's hearing condition.
A conference phone can be constructed with the following function modules: array signal processing, echo cancellation, and noise reduction and speech enhancement. Those functions can be implemented by using one or more than one of the chips.
A four-sensor microphone array for recording can be constructed by two chips each one has two microphone inputs or by one chip with 4 microphone inputs plus the array signal processing, and noise reduction and speech enhancement software modules.
A cell phone can be configured as a noise-reduction cell phone by adding a chip with two-channel noise reduction as shown in FIG. 11. One channel reduces the background noise picked by the microphone, and another channel reduces the noise from the entire communication channel and gives clear sound to the loudspeaker.

Alternatively, the noise reduction method can be implemented as a separate unit from the microphone component or loudspeaker in the form of hardware implementation or software program on a DSP or other type of computation units. This alternative implementation still preserves the quality of the enhanced speech. There are many alternative ways that the invention can be used, such as:
a noise reducing device for human-to-human communication in noisy environments such as conference speaker phone, cell phone, or communications between pilots and ground control;
a noise reducing device for human-to-machine communication in noisy environments such as human speech input to an ASR system;
a noise reducing device to enhance speech intelligibility such as in hearing aids;
a speech recognizer; and
a machine translator.

The present invention can be implemented on a digital system, analog system, mechanical system, or a combination of said systems in one silicon die or chip.

The present invention is not limited to remove background noise from speech signal. It can be used to remove any undesired signal and to enhance desired target signal. For example, the invention can be used to remove wind noise (undesired signal) and to enhance vehicle sound (target signal).

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A noise reduction and speech enhancement apparatus, comprising:
a computation unit including a programmable circuitry which implements a noise reduction and speech enhancement algorithm.
a sound receiving unit or generating unit.

2. The apparatus as claimed in claim 1, wherein said sound receiving unit can be one or more than one microphone component.

3. The apparatus as claimed in claim 1, wherein said sound generating unit can be one or more than one loudspeaker.

4. The apparatus as claimed in claim 1, wherein said computation unit can be within said sound receiving unit, or sound generating unit, or as a separate module at any stage within an application system.

5. The apparatus as claimed in claim 4, wherein said application system can be a wireless handset, conference phone, speaker phone, cordless phone, hearing aid, earphone, headset, telephone speech, wireless station, telephone switch, network router, or any device processing speech signals.

6. The apparatus as claimed in claim 1, wherein said programmable circuitry further comprises an analog-to-digit (A/D) converter, a digital signal processor (DSP), a memory including RAM or ROM, and a digit-to-analog (D/A) converter.

7. The apparatus as claimed in claim 6, wherein said noise reduction and speech enhancement algorithm and corresponding software implementation are pre-stored in said memory. All the functions are fabricated in one silicon die, and the die can be packaged as a chip when necessary. Alternatively, the die can also be packaged on a circuit board directly as system-on-board packaging.

8. The apparatus as claimed in claim 7, wherein said noise reduction and speech enhancement algorithm comprises a Cochlear Transform algorithm, which is implemented by said DSP.

9. The apparatus as claimed in claim 8, wherein said circuitry further comprises a bank of auditory-based filters or an array of auditory-based filters.

10. The apparatus as claimed in claim 9, wherein parameters of said auditory-based filters can be adjusted or adapted by a feedback method.

11. The apparatus as claimed in claim 10, wherein said feedback method is to use automatic speech recognition (ASR) error rates or other information related to the desired signal quality.

12. The apparatus as claimed in claim 11, wherein said ASR error rates are calculated by an ASR system and said other information are generated by a knowledge-based system.

13. The apparatus as claimed in claim 9, wherein said auditory-based filter banks are digital, analog, or mechanical. The filter bank has similar frequency response as the basilar membrane in the cochlear of hearing system. The filter bank decomposes received signal into different frequency bands for further processing.

14. The apparatus as claimed in claim 13, wherein output from each said auditory-based filter is then processed by a special nonlinear unit, which can be realized in forms of a hard-limit threshold, a log function, a nonlinear function, or an artificial neural network.

15. The apparatus as claimed in claim 14, wherein outputs of said nonlinear units after passing through a signal phase changer are added by an adder to re-synthesis the cleaned or processed speech signal.

16. The apparatus as claimed in claim 15, wherein said cleaned speech signal is then evaluated by an ASR system or a knowledge-based system. The evaluation results in terms of the quality of the processed speech are then fed back through a parameter optimizer or adaptor to adjust the parameters in the auditory filters and the nonlinear processor to further improve the quality of the processed sound.

17. A method for reducing noise in speech and enhancing speech quality, comprising the steps of:
receiving the speech signal;
sending received speech signal through a pre-amplifier;
converting the amplified signal into digital format using A/D converter;
transforming the digital signal to different frequency bands using the Cochlear Transform algorithm and the auditory-based filter bank;
estimating the background noise from filter bank output based on the pre-knowledge of speech and noise;
removing or reducing noise using a nonlinear function or unit;
re-synthesizing the processed, i.e. cleaned, signal through the Inverse Cochlear Transform;
converting the time-domain signal from digital format into analog signal through a digital-to-analog (“D/A”) converter if necessary;
outputting the analog or digital signal.

18. The method as claimed in claim 16, wherein the parameters of said bank of auditory-based filters can be adjusted using the ASR error rates or other estimated information to further improve the quality of the processed signal.
